(19) United States
(12) Patent Application Publication
(10) Pub. No.: US 2008/0019125 A1
(43) Pub. Date: Jan. 24, 2008

(54) BACKLIGHT MODULE

(75) Inventors: Nien-Hui Hsu, Hsinchu (TW); Shang-Hsuang Wu, Hsinchu (TW); Ching-Po Lee, Hsinchu (TW); Jin-Shu Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CORETRONIC CORPORATION, Hsinchu (TW)

(21) Appl. No.: 11/749,753

(22) Filed: May 17, 2007

(30) Foreign Application Priority Data
Jul. 21, 2006 (TW) 95126655

(51) Int. Cl. F21V 29/02

(52) U.S. Cl. 362/218; 362/235; 362/249

(57) ABSTRACT

A backlight module comprising a light box, a diffusion plate and at least a light source set is provided. The light box has a bottom and a light emitting section opposite to the bottom, the diffusion plate is disposed at the light emitting section, and the light source set is disposed on the bottom of the light box. In addition, the light source set includes a substrate and a plurality of point light sources, wherein the substrate is disposed on the bottom of the light box, and the point light sources are disposed on the substrate and face the light emitting section. Wherein, the bottom of the light box has a plurality of heat dissipation holes to expose a portion of the substrate, and another portion of the substrate is in contact with the bottom.

### CROSS-REFERENCE TO RELATED APPLICATION

This application claims the priority benefit of Taiwan application serial no. 95126655, filed Jul. 21, 2006. All disclosure of the Taiwan application is incorporated herein by reference.

### BACKGROUND OF THE INVENTION

1. Field of the Invention

The present invention relates to a plane light source. More particularly, the present invention relates to a backlight module.

2. Description of Related Art

Referring to FIG. 1A and FIG. 1B, the conventional backlight module 100 includes a plurality of light sets 120 disposed on a bottom 112 of a light box 110. Each of the light sets 120 includes a substrate 122 and a plurality of light emitting diodes (LEDs) 124 disposed on the substrate 122. In addition, a thermal interface material layer 130 is disposed between the substrate 122 and the light box 110.

The heat generated by the LEDs 124 is conducted to the thermal interface material layer 130 via the substrate 122, and then conducted to the bottom 112 of the light box 110 via the thermal interface material layer 130. Then, the heat in the bottom 112 of the light box 110 is exchanged with the air outside of the backlight module 100 by the manner of heat convection, thereby achieving the goal of heat dissipation.

Since the LEDs 124 of the conventional backlight module 100 exchange heat with the ambient air through the bottom 112 of the light box 110, though the heat dissipation area is relatively large, the heat dissipation efficiency is not good as the dissipation path is too long. Accordingly, the light emitting brightness of the LEDs 124 is likely to reduce because of the over-heat, and the light emitting wavelength will be changed for the same reason.

Referring to FIG. 2A and FIG. 2B, the conventional backlight module 100a includes a plurality of light sets 120 disposed on a bottom 112a of a light box 110a. Each of the light sets 120 includes a substrate 122 and a plurality of LEDs 124 disposed on the substrate 122. The bottom 112a of the light box 110a comprises a plurality of openings 114, and each opening 114 corresponds to a light set 120. Each of the openings 114 exposes a portion of one substrate 122 and is disposed right under all the LEDs 124 on each substrate 122.

The heat generated by the LEDs 124 is first conducted to the substrate 122. Since the contact area of the substrate 122 and the bottom 112a of the light box 110a is very small, the heat on the substrate 122 is hard to be conducted to the bottom 112a of the light box 110a. Instead, heat dissipation can only be achieved by the manner of heat convection that a heat exchange is carried out between the heat on the substrate 122 and the air outside of the backlight module 100a through the openings 114. Though the heat conduction path of the LEDs 124 of a is shorter than that of the backlight module 100, the contact area of the substrate 122 and the air outside of the backlight module 100a is too small to have good efficiency of heat convection when the flow of the ambient air is insufficient. Consequently, the LEDs 124 of the conventional backlight module 100a are easily overheated, which reduces the light emitting brightness and changes the light emitting wavelength.

### SUMMARY OF THE INVENTION

One objective of the present invention is to provide a backlight module to improve heat dissipation efficiency.

In order to achieve the above or other objectives, the present invention provides a backlight module comprising a light box and at least a light source set. The light box has a bottom and a light emitting section opposite to the bottom, and the light source set is disposed on the bottom of the light box. In addition, the light source set includes a substrate and a plurality of point light sources, wherein the substrate is disposed on the bottom of the light box, and the point light sources are disposed on the substrate and face the light emitting section. The bottom of the light box has a plurality of heat dissipation holes, and the heat dissipation holes are located at the position right under at Least part of the point light sources or at the position right under at least part of two adjacent point light sources.

Another backlight module is provided by the present invention, which comprises a light box and at least a light source set. The light box has a bottom and a light emitting section opposite to the bottom, and the light source set is disposed on the bottom of the light box. In addition, each of the light source sets includes a substrate and a plurality of point light sources, wherein the substrate is disposed on the bottom of the light box, and the point light sources are disposed on the substrate facing the light emitting section. An opening is formed at the overlapping area between the central region of the bottom and the substrate, and the opening partially exposes the central region of the bottom.

According to the backlight module of the present invention, a portion of the heat conducted from the point light sources to the substrate is directly exchanged with the ambient air by the manner of heat convection, and another portion of the heat is conducted to the bottom of the light box which has a larger area, and then heat convection between the bottom of the light box and the ambient air is carried out by heat exchange. Therefore, the backlight module of the present invention has better heat dissipation efficiency.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a top view of a conventional backlight module.

FIG. 1B is a cross-section view of FIG. 1A along line A-AN.

FIG. 2A is a top view of another conventional backlight module.

FIG. 2B is a cross-section view of FIG. 2A along line A-A′.

FIG. 3 is a cross-sectional side view of a backlight module according to the first embodiment of the present invention.

FIG. 4A is a top view of the light box and the light source sets of the backlight module in FIG. 3.

FIG. 4B is a cross-section view of FIG. 4A along line C-C′.

FIG. 4C is another cross-section view of FIG. 4A along line C-C′ according to another embodiment.

FIG. 5A is a top view of the light box and the light source sets of another backlight module according to the first embodiment of the present invention.

FIG. 5B is a cross-section view of FIG. 5A along line D-D′.

FIG. 6 is a cross-sectional side view of a backlight module according to the second embodiment of the present invention.

FIG. 7A is a top view of the light box and the light source of the backlight module in FIG. 6.

FIG. 7B is a cross-section view of FIG. 7A along line E-E′.

FIG. 7C is another cross-section view of FIG. 7A along line E-E′ according to another embodiment.

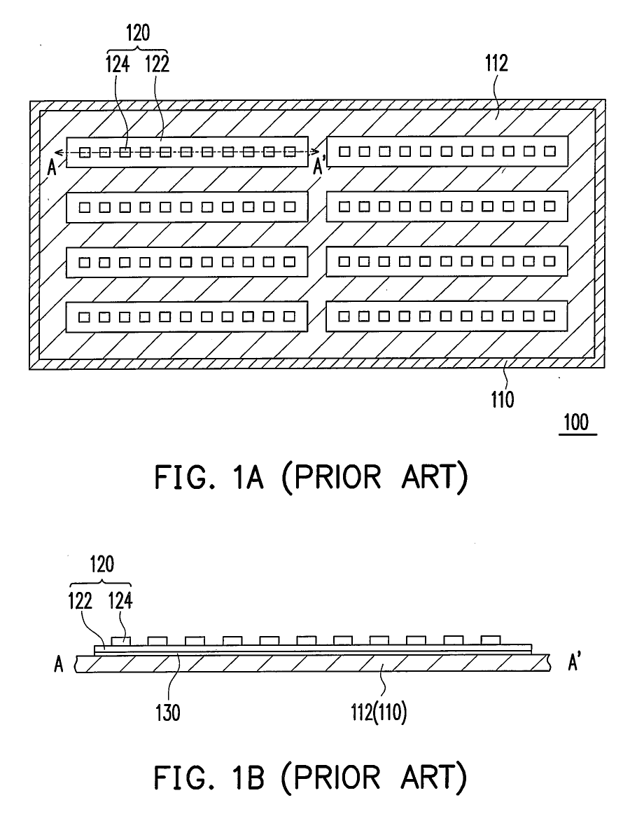

### DESCRIPTION OF EMBODIMENTS

### The First Embodiment

In the following detailed description of the preferred embodiments, reference is made to the accompanying drawings which form a part hereof, and in which is shown by way of illustration specific embodiments in which the invention may be practiced. In this regard, directional terminology, such as “over,” “under,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Accordingly, the drawings and descriptions will be regarded as illustrative in nature and not as restrictive.

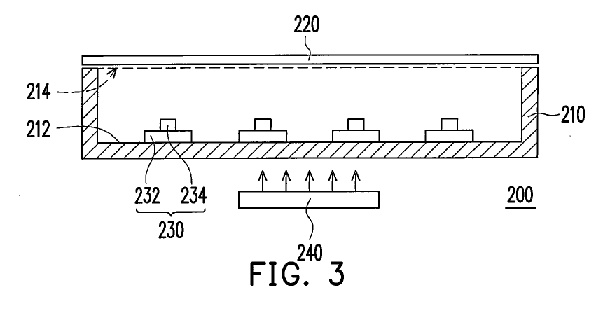

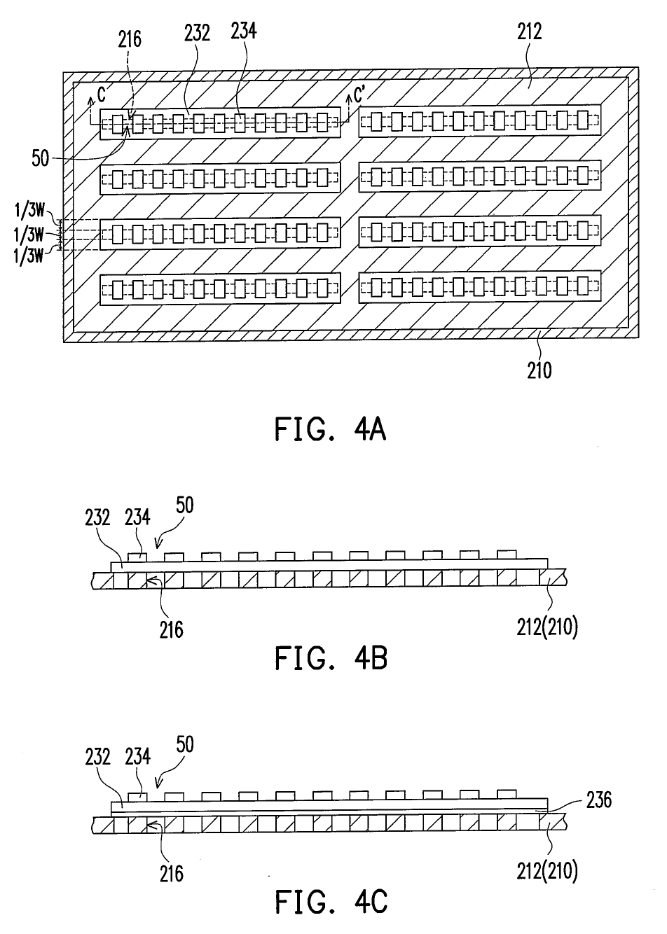

Referring to FIG. 3, FIG. 4A and FIG. 4B, the backlight module 200 of the first embodiment of the present invention includes a light box 210, a diffusion plate 220 and a plurality of light source sets 230. The light box 210 has a bottom 212 and a light emitting section 214 opposite to the bottom 212. The diffusion plate 220 is disposed over the light box 210, and the light source sets 230 are disposed on the bottom 210 of the light box 212. In addition, each of the light source sets 230 includes a substrate 232 and a plurality of point light sources 234, wherein the substrate 232 is disposed on the bottom 212 of the light box 210, and the point light sources 234 are disposed on the substrate 232 and face the light emitting section 214. The bottom 212 of the light box 210 has a plurality of heat dissipation holes 216 to partially expose the substrate 232, and the rest of the substrate 232 is in contact with the bottom 212. In the embodiment, the heat dissipation hole 216 is, for example, disposed right under the position 50 between two adjacent light point sources 234.

Each of the substrates 232 is, for example, in a shape of strip, and the point light sources 234 are arranged in row extending toward each substrate 232. The substrate 232 is a circuit board, and the material thereof includes, but not limited to, metal or alloy with better heat conductibility. In specific, the substrate 232 can be a metal core printed circuit board (MCPCB). The material of the light box 210 includes, but not limited to, aluminum or other metal or alloy with better heat conductibility. The point light sources 234 can be LEDs. For example, the width of the substrate 232 is W, the width of the heat dissipation holes 216 is ⅓W, and the shortest distance from either of the two longitudinal sides of the substrate 232 to the heat dissipation hole 216 is, for example, ⅓W (as shown in FIG. 4A).

In the embodiment, the heat generated by the point light sources 234 is first conducted to the substrate 232. Since the bottom 212 of the light box 210 has a plurality of heat dissipation holes 216, the heat exchange between the ambient air outside of the light box 210 and the substrate 232 is directly carried out by the manner of heat convection through the heat dissipation holes 216. In addition, a portion of the heat conducted to the substrate 232 is conducted to the bottom 212 of the light box 210, and the ambient air outside of the light box 210 is heat exchanged with the bottom 212 of the light box 210 by the manner of heat convection.

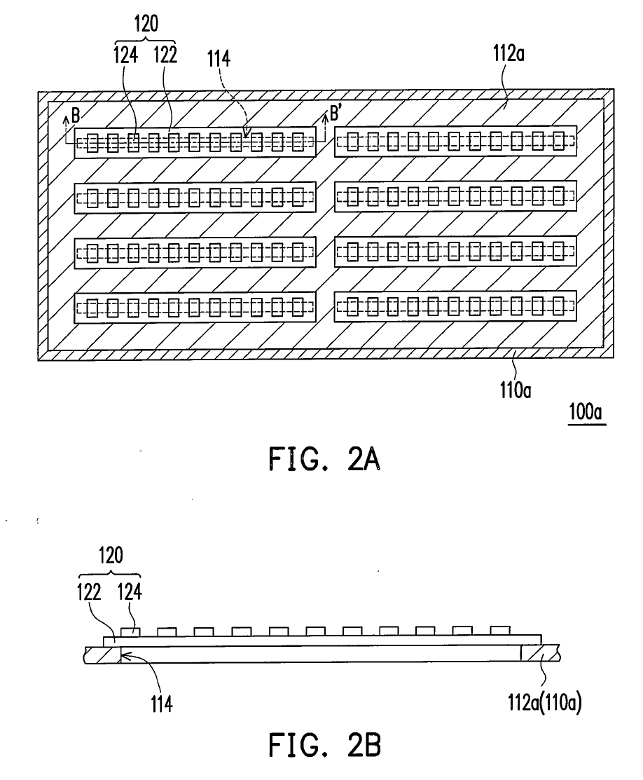

Compared with the conventional backlight module 100, in the embodiment, not only the heat generated by the point light sources 234 is exchanged with the ambient air through the bottom 212 of the light box 210, but also a heat exchange is carried out directly between the ambient air and the substrate 232 through the heat dissipation holes 216. Therefore, the backlight module 200 has better heat dissipation efficiency when comparing with the conventional backlight module 100. Besides, compared with the conventional backlight module 100a (as shown in FIG. 2A) which has only one opening 114 on the bottom 112a of the light box 110a, the contact area of the substrate 232 and the bottom 212 in the embodiment is increased as the bottom 212 of the light box 210 has a plurality of heat dissipation holes 216. When the flow of the ambient air is insufficient, the heat generated by the point light sources 234 still can be exchanged with the ambient air through the bottom 212 of the light box 210. Thus, compared with the conventional backlight module 100a, the backlight module 200 has better heat dissipation efficiency.

Since the backlight module 200 has better heat dissipation efficiency, the light emitting brightness of the point light sources 234 is not easily lowered and the light emitting wavelength does not easily have a change that occurs as a result of overheat. Therefore, the backlight module 200 of the present embodiment provides a plane light source with more uniform brightness and stable wavelength.

To further improve the heat dissipation efficiency of the backlight module 200, a thermal interface material layer 236 as shown in FIG. 4C can be disposed between the substrate 232 and the bottom 212 of the light box 210. Referring to FIG. 3, a fan 240 is additionally disposed outside of the light box 210 according to the present embodiment, and the blowing direction of the fan 240 is toward the bottom 212 of the light box 210 so as to guide the air current to cool the light box 210, the substrate 232 and the point light sources 234. As a result, the heat dissipation efficiency of the backlight module 200 is further improved.

Please note that, in the backlight module 200, the light source set(s) 230 can be one or plural; the present invention does not restrict the number of the light source sets 230. Though the heat dissipation holes 216 are disposed right under all the positions between every two adjacent light point sources 234, the present invention, however, does not restrict that the heat dissipation holes 216 are required to be disposed under all the positions between each two adjacent point light sources 234. In other words, the heat dissipation holes 216 are disposed right under the positions between some of two adjacent light point sources 216. The shape of the heat dissipation holes 216 illustrated in FIG. 4A is rectangular, but the shape can be circular, polygonal or the like. The present invention does not limit the shape of the heat dissipation holes 216.

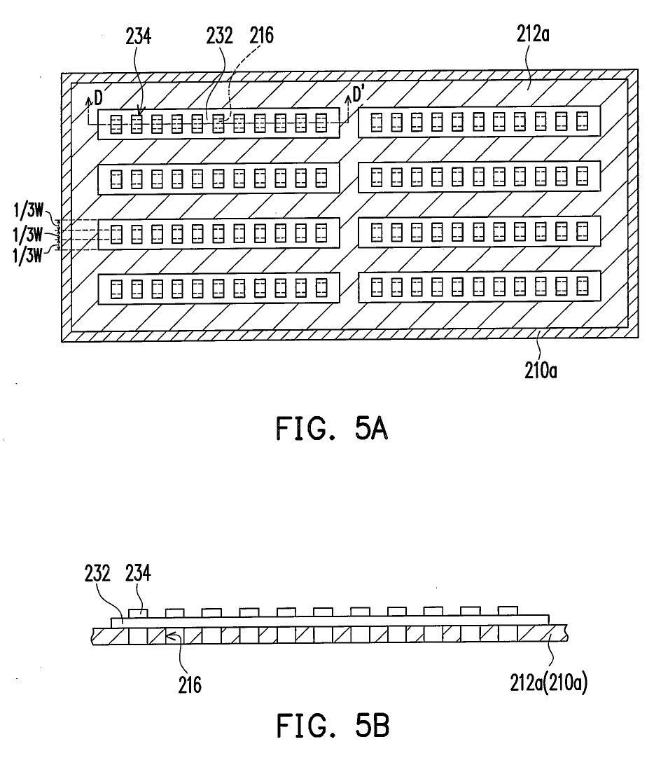

Referring to FIG. 5A and FIG. 5B, a light box 210a of another type of the backlight module similar to the light box 210 shown in FIG. 4A according to the first embodiment is illustrated. The difference is that each of the heat dissipation holes 216 at the bottom 212a of the light box 210a is disposed right under each of the point light sources 234. In other words, in addition to being disposed right under the position between two adjacent point light sources 234, the heat dissipation hole 216 of the present invention can be disposed right under the point light source 234. Please note that, in the present invention, the heat dissipation hole 216 is not limited to being disposed right under the point light source 234 or right under the position between two adjacent point light sources 234. Furthermore, the present embodiment does not restrict that the heat dissipation holes 216 are required to be disposed under all the point light sources 234. In other words, the heat dissipation holes 216 may be disposed right under some of the light point sources 216.

### The Second Embodiment

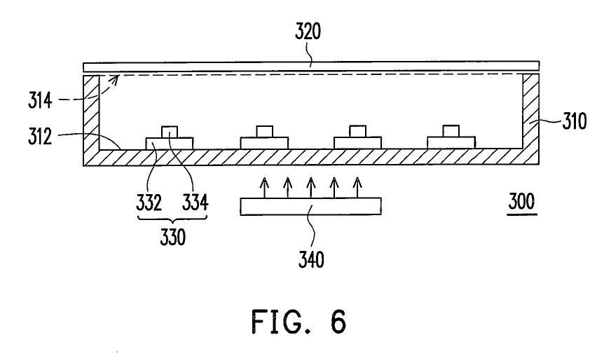

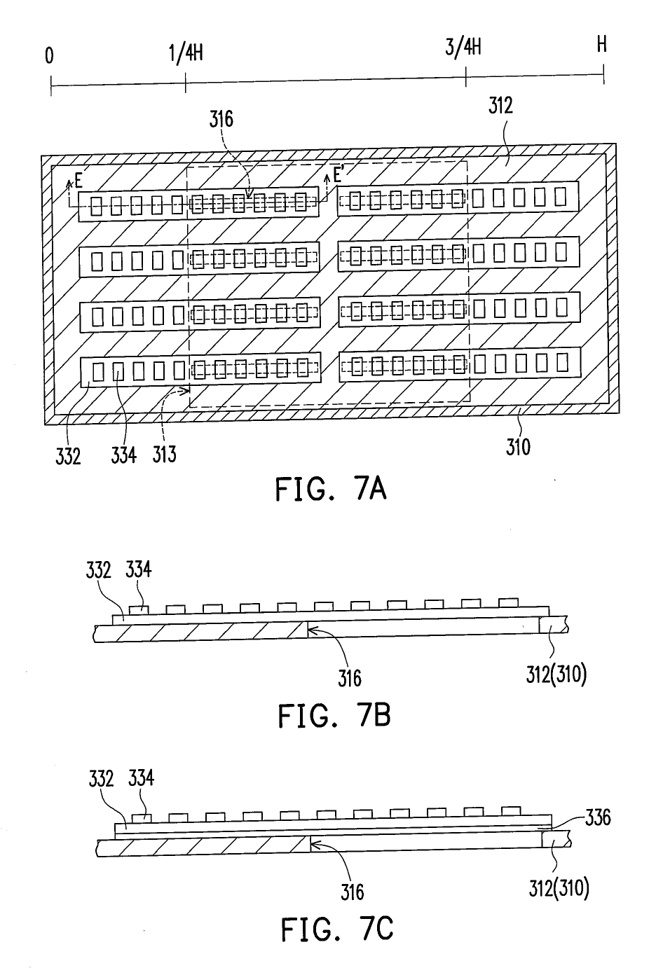

Referring to FIG. 6, FIG. 7A and FIG. 7B, the backlight module 300 of the second embodiment of the present invention includes a light box 310, a diffusion plate 320 and a plurality of light source sets 330. The light box 310 has a bottom 312 and a light emitting section 314 opposite to the bottom 310, the diffusion plate 320 is disposed over the light box 310, and the light source sets 330 are disposed on the bottom 310 of the light box 312. In addition, each of the light source sets 330 includes a substrate 332 and a plurality of point light sources 334, wherein the substrate 332 is disposed on the bottom 312 of the light box 310, the point light sources 334 are disposed on the substrate 332, and the point light sources 334 are LEDs, for example. An opening 316 is respectively formed at the overlapping area between each the substrate 332 and the central region 313 of the bottom 312 of the light box 310, and each of the openings 316 exposes a portion of the substrate 332 located at the central region 313 of the bottom 312.

The shape of the bottom 312 of the light box 310 is, for example, rectangular. The longitudinal length of the rectangle is H, and that of the central region 313 of the bottom 312 is, for example, between ¼ H to ¾ H. However, this should by no means limit the scope of the present invention. In addition, the backlight module 300 further includes a fan 340 disposed outside of the light box 310. The blowing direction of the fan 340 is toward the central region 313 of the bottom 312 of the light box 310.

Each of the substrates 332 is, for example, in a shape of strip, and the point light sources 334 are arranged in row extending toward a longitudinal direction of each substrate 332. The substrate 332 is a circuit board, and the material thereof includes, but not limited to, metal or alloy with better heat conductibility. In specific, the substrate 332 can be a metal core printed circuit board (MCPCB). The material of the light box 310 includes, but not limited to, aluminum or other metal or alloy with better heat conductibility. In addition, the width of the substrate 332 is W, the width of the openings 316 is, for example, ⅓W, and the shortest distance from either of the two longitudinal sides of the substrate 332 to the opening 316 is, for example, ⅓W.

In the embodiment, the heat generated by the point light sources 334 is first conducted to the substrate 332. When the fan is under operation, most of the air is blown toward the central region 313 of the bottom 312 of the light box 310; therefore, in the present embodiment, plural openings are disposed in the central region 313 of the bottom 312 of the light box 310 in order to have the ambient air outside of the light box 310 directly blown toward the substrate 332 through the openings 316, thereby effectively dissipating the heat on the substrate 332. In addition, the area out of the central region 313 of each substrate 332 is in contact with the bottom 312 of the light box 310, therefore, the heat on the substrate 332 can be conducted to the bottom 312 of the light box 310 with a larger heat-dissipating area to improve heat dissipation efficiency.

As described, since the backlight module 300 has better heat dissipation efficiency, the light emitting brightness of the point light sources 334 is not easily lowered and the light emitting wavelength does not easily have a change that occurs as a result of the overheat. Therefore, the backlight module 300 of the present embodiment provides a plane light source with more uniform brightness and stable wavelength.

Please note that, in the backlight module 300, the light source set(s) 330 can be one or plural; the present invention does not restrict the number of the light source sets 330. In addition, though the shape of the openings 316 illustrated in FIG. 7A is rectangular, the present invention does not restrict the shape of the openings 316. To further improve the heat dissipation efficiency of the backlight module 300, a thermal interface material layer 336 (as shown in FIG. 7C) can be disposed between the substrate 332 and the bottom 310 of the light box 312.

In summary, in the backlight module of the present invention, a portion of the heat conducted from the point light sources to the substrate is directly exchanged with the ambient air by the manner of heat convection, and another portion of the heat is conducted to the bottom of the light box which has a larger heat-dissipating area, and then a heat exchange between the bottom of the light box and the ambient air is carried out by manners of heat convection. Thus, the backlight module of the present invention has better heat dissipation efficiency and the light emitting brightness and light emitting wavelength will not be easily affected by the overheat. In other words, the backlight module of the present embodiment provides a plane light source with more uniform brightness and stable wavelength.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “tile invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. An)y advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a light box having a bottom and a light emitting section opposite to each other; and
at least a light source set disposed on the bottom of the light box, wherein the light source set comprises:
a substrate disposed on the bottom of the light box; and
a plurality of point light sources disposed on the substrate and facing the light emitting section,
wherein, the bottom of the light box has a plurality of heat dissipation holes to expose a portion of the substrate, and another portion of the substrate is in contact with the bottom.

2. The backlight module as claimed in claim 1, wherein the heat dissipation holes are disposed right under at least part of the point light sources.

3. The backlight module as claimed in claim 1, wherein the heat dissipation holes are disposed right under at least some of positions between each two adjacent point light sources.

4. The backlight module as claimed in claim 1, wherein the substrate is in a shape of strip.

5. The backlight module as claimed in claim 1, wherein the point light sources comprise LEDs and are arranged in row extending toward a longitudinal direction of the substrates.

6. The backlight module as claimed in claim 1, wherein a material of the light box comprises metal.

7. The backlight module as claimed in claim 1, further comprising a thermal interface material layer disposed between the substrate and the bottom of the light box.

8. The backlight module as claimed in claim 1 further comprising a fan disposed outside of the light box to guide air current to cool down the light box, the substrate and the point light sources.

9. The backlight module as claimed in claim 1 further comprising a diffusion plate disposed over the light box.

10. The backlight module as claimed in claim 1, wherein a width of the substrate is W. a width of the heat dissipation holes is ⅓W, and a shortest distance from either of two longitudinal sides of the substrate to the heat dissipation holes is ⅓W.

11. A backlight module, comprising:
a light box having a bottom and a light emitting section opposite to each other; and
at least a light source set disposed on the bottom of the light box, wherein the light source set comprises:
a substrate disposed on the bottom of the light box; and
a plurality of point light sources disposed on the substrate and facing the light emitting section,
wherein, the bottom of the light box has an opening, the opening is disposed right under a portion of the point light sources to expose a portion of the substrate, and another portion of the substrate is in contact with the bottom.

12. The backlight module as claimed in claim 11, wherein the bottom of the light box has a central region, and the opening is disposed in the central region.

13. The backlight module as claim in claim 12, wherein the bottom of the light box is in a shape of rectangle, a longitudinal length of the rectangle is H, and the central region of the bottom is between ¼H and ¾H.

14. The backlight module as claimed in claim 11, wherein the substrate is in a shape of strip.

15. The backlight module as claimed in claim 11, wherein the point light sources comprise LEDs

16. The backlight module as claimed in claim 11, wherein a material of the light box comprises metal.

17. The backlight module as claimed in claim 11 further comprising a thermal interface material layer disposed between the substrate and the bottom of the light box.

18. The backlight module as claimed in claim 11 further comprising a fall disposed outside of the light box to guide air current to cool down the light box, the substrate and the point light sources.

19. The backlight module as claimed in claim 11 further comprising a diffusion plate disposed over the light box.
